(19) United States
(12) Patent Application Publication
(10) Pub. No.: US 2023/0394376 A1
(43) Pub. Date: Dec. 7, 2023

(54) TECHNIQUES FOR AUTOMATED DECISION MAKING IN WORKFLOWS

(71) Applicant: VIANAI SYSTEMS, INC., Palo Alto, CA (US)

(72) Inventors: Naama Parush Shear YASHUV, Jerusalem (IL); Ohad LEVINKRON-FISCH, Tel Aviv (IL); Jacob KLEIN, Ra’anana (IL); Gerben OOSTRA, Haarlem (NL)

(21) Appl. No.: 18/326,964

(22) Filed: May 31, 2023

Related U.S. Application Data
(60) Provisional application No. 63/347,924, filed on Jun. 1, 2022.

(51) Int. Cl. G06N 20/20

(52) U.S. Cl. CPC G06N 20/20

(57) ABSTRACT

One embodiment of a method for automated decision making includes receiving a first set of features associated with a decision in a workflow, generating, using a trained causal inference machine learning model that predicts one or more effects of one or more actions on an outcome, a first action to perform in the workflow based on the first set of features, and transmitting one or more messages to one or more computing devices based on the first action.

### CROSS-REFERENCE TO RELATED APPLICATIONS

This application claims priority benefit of the United States Provisional Patent Application titled, “CAUSAL INFERENCING SYSTEM FOR WORKFLOW OPTIMIZATION,” filed on Jun. 1, 2022, and having Ser. No. 63/347,924. The subject matter of this related application is hereby incorporated herein by reference.

### BACKGROUND

### Technical Field

Embodiments of the present disclosure relate generally to computer science and machine learning and, more specifically, to techniques for automated decision making in workflows.

### Description of the Related Art

Workflows are repeatable sequences of processes and/or tasks that occur in a particular order. Workflows oftentimes include one or more steps at which decisions need to be made. For example, a marketing workflow can include a step at which a decision needs to be made on whether, how, and/or when to contact a marketing lead in order to convert the marketing lead. As used herein, a “marketing lead” (also referred to herein as a “lead”) is someone who has shown interest in a product or service, and “converting” refers to a lead performing a desired action, such as purchasing the product or service. As another example, a healthcare workflow can include a step at which a decision needs to be made on the course of action for improving a patient outcome, such as running a test, prescribing a treatment, or waiting without treatment to see how a condition develops.

One conventional approach for making decisions in workflows is for a user to make decisions based on his or her intuition and personal experience. In some cases, the user decisions are guided by predictions of outcomes of those decisions. For example, predefined metrics and heuristics can be used to calculate a score associated with the outcome of a decision, and a user can decide on an action to take given the score. In the context of a marketing workflow, a score can be calculated that indicates the estimated likelihood of a particular lead converting after the lead is contacted. As another example, a trained machine learning model can be used to predict an outcome assuming that decisions are made according to training data that was used to train the machine learning model, and a user can decide on an action to take given the prediction by the trained machine learning model. For example, in the context of a marketing workflow, a trained machine learning model can be used to predict the probability that a particular lead will convert.

One drawback of the above approach is that, even when a score is calculated using metrics and heuristics or an outcome is predicted using a trained machine learning model, the decision on an action to take is typically made by a user who interprets the score or predicted outcome using his or her own judgment. Few, if any, effective techniques currently exist for making workflow decisions without requiring a user to rely on his or her own judgment. For example, one simple approach for making decisions without requiring user judgment is to determine a decision based on whether the probability of an outcome, which can be predicted using a trained machine learning model, satisfies a threshold. However, such an approach is oftentimes ineffective because there is no good way to set the threshold for the predicted probability of the outcome, which typically has nothing to do with making good decisions.

In addition, when user decision making is guided by a calculated score or an outcome that is predicted using a trained machine learning model, the user can make undesirable decisions. Returning to the marketing workflow example, when a user decides whether to contact a lead based on a score assigned to the lead or a prediction of whether the lead is likely to convert, the user can end up deciding to contact leads who would have converted irrespective of being contacted, to contact leads in situations where such contact has an adverse impact on conversion, and/or to not contact leads who have a low chance of conversion without being contacted, but would convert had they been contacted.

As the foregoing illustrates, what is needed in the art are more effective techniques making decisions in workflows.

### SUMMARY

One embodiment of the present disclosure sets forth a computer-implemented method for automated decision making. The method includes receiving a first set of features associated with a decision in a workflow. The method further includes generating, using a trained causal inference machine learning model that predicts one or more effects of one or more actions on an outcome, a first action to perform in the workflow based on the first set of features. In addition, the method includes transmitting one or more messages to one or more computing devices based on the first action.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, in the disclosed techniques, machine learning models are trained and then used to generate prescriptive actions to perform in workflows, as opposed to predicting outcomes assuming that decisions are made according to training data that was used to train a machine learning model. The prescriptive actions can be generated and performed automatically, without requiring intervening user judgment. In addition, experience has shown that the prescriptive actions can be relatively effective. These technical advantages represent one or more technological improvements over prior art approaches.

### BRIEF DESCRIPTION OF THE DRAWINGS

So that the manner in which the above recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computer system configured to implement one or more aspects of the various embodiments;

FIG. 2 illustrates in greater detail the policy generating server of FIG. 1, according to various embodiments;

FIG. 3 illustrates in greater detail the policy of FIG. 1, according to various embodiments;

FIG. 4 illustrates in greater detail the policy generator of FIG. 1, according to various embodiments;

FIG. 5 sets forth a flow diagram of method steps for generating a policy, according to various embodiments;

FIG. 6 sets forth a flow diagram of method steps for training an effect predictor model, according to various embodiments;

FIG. 7 sets forth a flow diagram of method steps for selecting a policy associated with a decision point, according to various embodiments; and

FIG. 8 sets forth a flow diagram of method steps for making workflow decisions using a policy, according to various embodiments.

### DETAILED DESCRIPTION

In the following description, numerous specific details are set forth to provide a more thorough understanding of the present invention. However, it will be apparent to one of skill in the art that embodiments of the present invention may be practiced without one or more of these specific details.

### System Overview

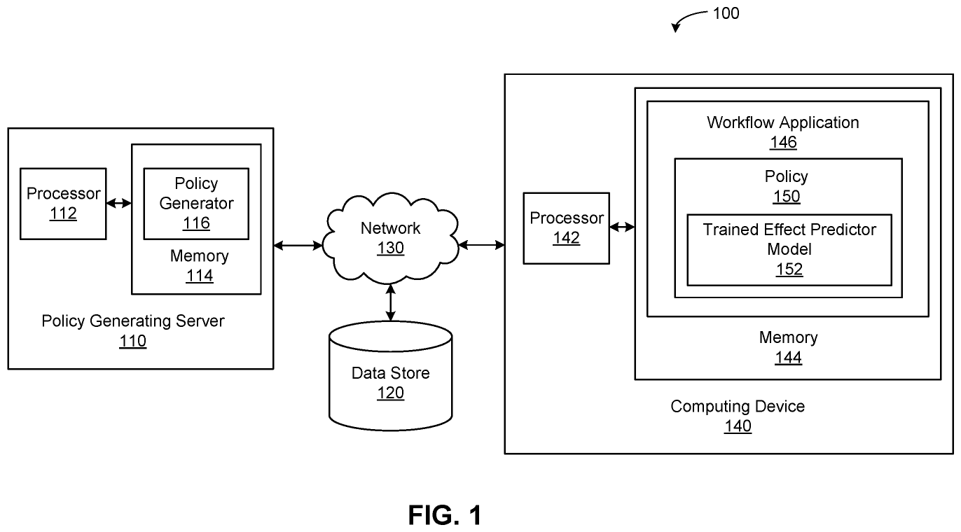

FIG. 1 illustrates a system 100 configured to implement one or more aspects of the various embodiments. As shown, the system 100 includes a policy generating server 110, a data store 120, and a computing device 140 in communication over a network 130, which may be a wide area network (WAN) such as the Internet, a local area network (LAN), or any other suitable network.

As shown, a policy generator 116 executes on a processor 112 of the policy generating server 110 and is stored in a memory 114 of the policy generating server 110. The processor 112 receives user input from input devices, such as a keyboard, a mouse, a joystick, a touchpad, or a touchscreen. In operation, the processor 112 is the master processor of the policy generating server 110, controlling and coordinating operations of other system components. In particular, the processor 112 may issue commands that control the operation of a graphics processing unit (GPU) that incorporates circuitry optimized for graphics and video processing, including, for example, video output circuitry. The GPU may deliver pixels to a display device that may be any conventional cathode ray tube, liquid crystal display, light-emitting diode display, or the like.

The memory 114 of the policy generating server 110 stores content, such as software applications and data, for use by the processor 112 and the GPU. The memory 114 may be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) may supplement or replace the memory 114. The storage may include any number and type of external memories that are accessible to the processor 112 and/or the GPU. For example, and without limitation, the storage may include a Secure Digital Card, an external Flash memory, a portable compact disc read-only memory (CD-ROM), an optical storage device, a magnetic storage device, or any suitable combination of the foregoing.

It will be appreciated that the policy generating server 110 shown herein is illustrative and that variations and modifications are possible. For example, the number of processors 112, the number of GPUs, the number of system memories 114, and the number of applications included in the memory 114 may be modified as desired. Further, the connection topology between the various units in FIG. 1 may be modified as desired. In some embodiments, any combination of the processor 112, the memory 114, and a GPU may be replaced with any type of virtual computing system, distributed computing system, or cloud computing environment, such as a public, private, or a hybrid cloud.

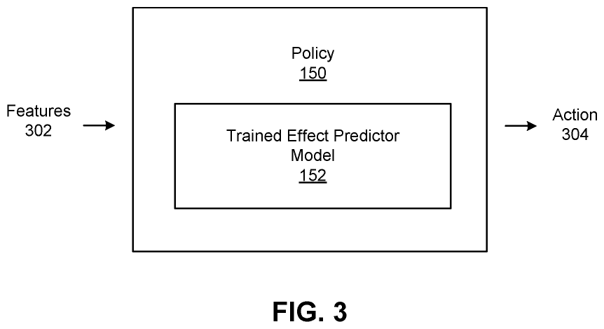

As discussed in greater detail below, the policy generator 116 is configured to generate policy models (also referred to herein as “policies”), including a policy 150. The policy 150 is a model that takes features as input and outputs an action. As shown, the policy 150 includes a trained effect predictor model 152 (also referred to herein as “effect predictor model 152”). The effect predictor model 152 is a trained machine learning model that takes features as input and outputs an estimated effect of an action on an outcome given the features. Architectures of the policy 150 and the effect predictor model 152, as well as techniques for generating and training the same, are discussed in greater detail below in conjunction with FIGS. 3-7. Training data and/or models, including the policy 150 and/or the effect predictor model 152, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the policy generating server 110 may include the data store 120.

The policy 150 can be deployed to any suitable applications in some embodiments. Illustratively, a workflow application 146 that utilizes the policy 150 is stored in a memory 144, and executes on a processor 142, of the computing device 140. In some embodiments, the workflow application 146 can be an application that determines actions to perform using the policy 150 and performs the actions. In some other embodiments, the workflow application 146 can be an application that determines actions to perform and transmits the actions to the devices of users who perform the actions (e.g., to the devices of salespeople who contact marketing leads in the marketing workflow example, or the devices of healthcare professionals in the healthcare workflow example). Components of the computing device 140, including the memory 144 and the processor 142, may be similar to corresponding components of the policy generating server 110.

The number of servers and computing devices may be modified as desired. Further, the functionality included in any of the applications may be divided across any number of applications or other software that are stored and execute via any number of devices that are located in any number of physical locations.

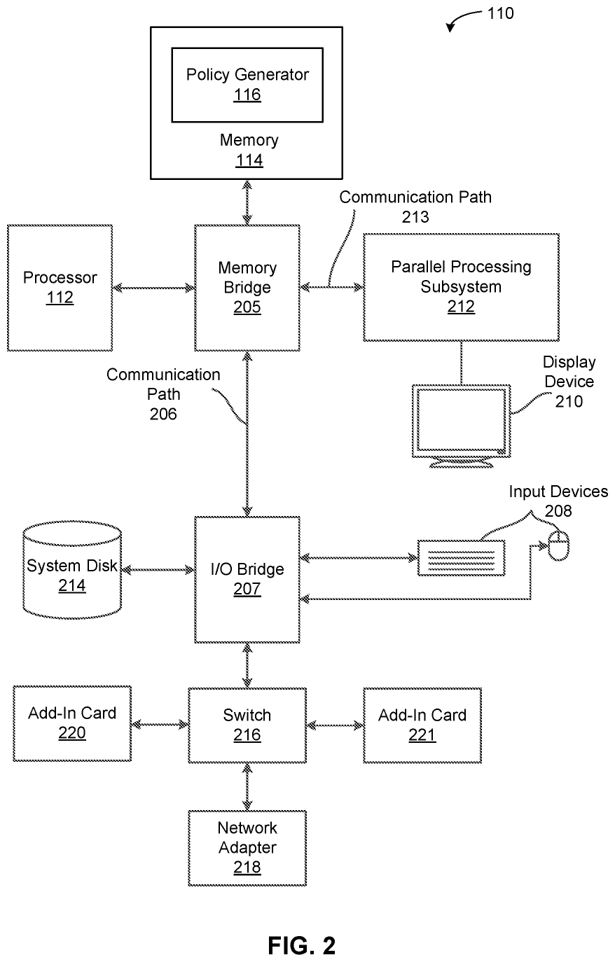

FIG. 2 illustrates in greater detail the policy generating server 110 of FIG. 1, according to various embodiments. As persons skilled in the art will appreciate, the policy generating server 110 can be any type of technically feasible computer system, including, without limitation, a server machine, a server platform, a desktop machine, laptop machine, a hand-held/mobile device, or a wearable device. In some embodiments, the policy generating server 110 is a server machine operating in a data center or a cloud computing environment that provides scalable computing resources as a service over a network. In some embodiments, the computing device 140 can include similar components as the policy generating server 110.

In various embodiments, the policy generating server 110 includes, without limitation, the processor 112 and the memory 114 coupled to a parallel processing subsystem 212 via a memory bridge 205 and a communication path 213. The memory bridge 205 is further coupled to an I/O (input/output) bridge 207 via a communication path 206, and the I/O bridge 207 is, in turn, coupled to a switch 216.

In some embodiments, the I/O bridge 207 is configured to receive user input information from optional input devices 208, such as a keyboard or a mouse, and forward the input information to the processor 112 for processing via the communication path 206 and the memory bridge 205. In some embodiments, the policy generating server 110 may be a server machine in a cloud computing environment. In such embodiments, the policy generating server 110 may not have input devices 208. Instead, the policy generating server 110 may receive equivalent input information by receiving commands in the form of messages transmitted over a network and received via the network adapter 218. In some embodiments, the switch 216 is configured to provide connections between the I/O bridge 207 and other components of the policy generating server 110, such as a network adapter 218 and various add-in cards 220 and 221.

In some embodiments, the I/O bridge 207 is coupled to a system disk 214 that may be configured to store content and applications and data for use by the processor 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to the I/O bridge 207 as well.

In various embodiments, the memory bridge 205 may be a Northbridge chip, and the I/O bridge 207 may be a Southbridge chip. In addition, communication paths 206 and 213, as well as other communication paths within the policy generating server 110, may be implemented using any technically suitable protocols, including, without limitation, AGP (Accelerated Graphics Port), HyperTransport, or any other bus or point-to-point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. Such circuitry may be incorporated across one or more parallel processing units (PPUs), also referred to herein as parallel processors, included within the parallel processing subsystem 212. In other embodiments, the parallel processing subsystem 212 incorporates circuitry optimized for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and compute processing operations. The system memory 114 includes at least one device driver configured to manage the processing operations of the one or more PPUs within the parallel processing subsystem 212. In addition, the system memory 114 includes the policy generator 116. Although described herein primarily with respect to the policy generator 116, techniques disclosed herein can also be implemented, either entirely or in part, in other software and/or hardware, such as in the parallel processing subsystem 212.

In various embodiments, the parallel processing subsystem 212 may be integrated with one or more of the other elements of FIG. 2 to form a single system. For example, the parallel processing subsystem 212 may be integrated with the processor 112 and other connection circuitry on a single chip to form a system on chip (SoC).

In some embodiments, the processor 112 is the master processor of the policy generating server 110, controlling and coordinating operations of other system components. In some embodiments, the processor 112 issues commands that control the operation of PPUs. In some embodiments, the communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 202, and the number of parallel processing subsystems 212, may be modified as desired. For example, in some embodiments, the system memory 114 could be connected to processor 112 directly rather than through the memory bridge 205, and other devices would communicate with system memory 114 via the memory bridge 205 and the processor 112. In other embodiments, the parallel processing subsystem 212 may be connected to the I/O bridge 207 or directly to the processor 112, rather than to the memory bridge 205. In still other embodiments, the I/O bridge 207 and the memory bridge 205 may be integrated into a single chip instead of existing as one or more discrete devices. In certain embodiments, one or more components shown in FIG. 2 may not be present. For example, the switch 216 could be eliminated, and the network adapter 218 and the add-in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Automated Decision Making in Workflows

FIG. 3 illustrates in greater detail the policy 150 of FIG. 1, according to various embodiments. As shown, the policy 150 includes the trained effect predictor model 152. Given features 302 as input, the policy 150 uses the trained effect predictor model 152 to generate an action 304 at a decision in a workflow. As used herein, a decision in a workflow involves choosing between two or more potential actions that can be performed. A decision and associated actions can be defined in any technically feasible manner in some embodiments, such as manually based on domain expertise and/or with the assistance of automated tools. Depending on the workflow and the decision, any suitable features can be input into the policy 150, and the policy 350 can output any suitable action(s) in some embodiments. Returning to the marketing workflow example, in some embodiments, the features can include characteristics of a marketing lead (e.g., an age and state of residence of the lead), characteristics of an item (e.g., a value of the item), a stage in the marketing process (e.g., ready to buy), communication history with the lead (e.g., all prior messages and phone calls) including communication times and quantities as well as communication content, a time/date/season (or other features independent of the lead or item that can affect the action and outcome), and/or characteristics (e.g., the experience) of a sales representative. In such cases, the features can be obtained from customer relations management (CRM) system(s) that include databases of leads and interactions with the leads, marketing automation system(s), advertisement platform(s), and/or other source(s) that are related to marketing. In some embodiments, a subset of features can be selected for use by the policy 150. For example, in some embodiments, a feature selection technique for uplift modeling can be used to select a number (e.g., 50) of leading features. In addition, in the marketing workflow example, the action that the policy 150 outputs can include whether to contact a lead, whether to forward the lead to a sales representative, a particular time to contact the lead, etc. Although described herein primarily with respect to marketing workflows as a reference example, techniques disclosed herein can be used to generate prescriptive actions for any suitable workflows, such as the healthcare workflows described above.

In some embodiments, the effect predictor model 152 is a trained causal inference machine learning model that takes features as input and outputs an estimated effect of an action on an outcome given the features. In such cases, the effect of the action can be a difference in the probability of the outcome between performing and not performing the action. The effect predictor model 152 can be trained on historical data and used to estimate the effect of a given action. In some embodiments, the effect predictor model 152 can include any technically feasible causal machine learning model that is trained to optimize for what action should be performed. For example, in some embodiments, the effect predictor model 152 can include a causal forest model. As a particular example, in some embodiments, the effect predictor model 152 can include an ensemble of uplift random forest models that are trained by the policy generator 116 using CausalML and averaged over all predictions as the final effect estimate. As another example, in some embodiments, the effect predictor model 152 can include a logistical regression model. As yet another example, in some embodiments, the effect predictor model 152 can include an artificial neural network. The policy 150 is a function of effect estimates output by the effect predictor model 152 (and potentially other inputs). For example, in some embodiments, the policy 150 can be generated from the effect predictor model 152 by setting a threshold over effect estimates output by the effect predictor model 152. Returning to the marketing workflow example, the effect predictor model 152 could predict whether an action, such as contacting a lead, will increase the chances of a lead conversion or not. In such cases, the threshold could be set to 0, such that an action is output by the policy 150 when the effect predictor model 152 predicts that the action will increase the chances of a lead conversion.

More formally, a policy π can be defined as:

π(x):x→A,

where x is a feature space representing the context at a given decision (also referred to herein as “effect modifiers”), and A is an action. The goal is to produce a policy that maximizes an objective. Returning to the marketing workflow example, the action can be whether or not to contact a lead, and an objective can be defined as the sum of sales over all leads in a time period. Leads are assumed to be independent, so that the action on one lead does not affect the sales of other leads. Under such an assumption, decisions for each lead can be optimized separately. For a specific decision for a lead, the optimal policy should recommend the action that maximizes the probability of a conversion:

$${π}_{optimal} ( lead ) = {max}_{A} P ( {sales}_{A} )$$

Where the quantity P(sales_{A}) represents the probability of a conversion if the decision were to take action A. sales_{A} is a potential outcome: for a given lead, only a single action is chosen and a single outcome sales_{A} is realized. This is called the “factual” outcome, and the values of sales_{A} for other actions are called “counterfactual” and can never be observed. In the simple case of a binary action, such as contacting or not contacting a lead, a (counterfactual) quantity called the “effect” of the action on conversions can be defined as the difference in the probability of a conversion between doing and not doing A. In some embodiments, for a given lead, such an effect can be estimated based on the features x that describe the lead as a conditional average treatment effect (CATE):

CATE(x)=P(sales_{A=1}|x)−P(sales_{A=0}|x)

The policy that optimizes the objective above can be to do A if the CATE is positive, and not do A if the CATE is negative. It should be noted that, in contrast to supervised learning, such a setting has no “label,” as the

$${max}_{A} P ( {sales}_{A} )$$

and the effect of A on sales are never observed. Nevertheless, the counterfactual “label” can be estimated using data of leads with different values of A, assumptions on the data generating process for A and sales_{A}, and causal inference.

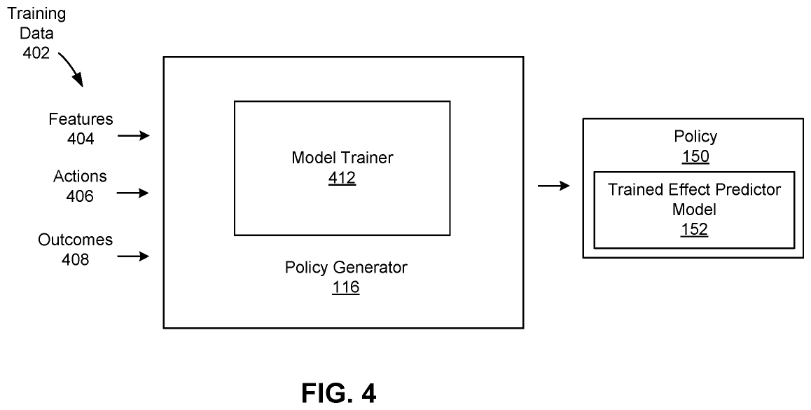

FIG. 4 illustrates in greater detail the policy generator 116 of FIG. 1, according to various embodiments. In operation, the policy generator 116 takes as input training data 402 that includes features 404, actions 406, and outcomes 408 from historical data, and the policy generator 116 generates and outputs a policy that includes a trained effect predictor model that is a causal inference machine learning model, shown as the policy 150 that includes the effect predictor model 152. The actions 406 can be considered a special feature, and actions are sometimes also referred to herein as “treatments.” As shown, the policy generator 116 includes a model trainer 412 that trains effect predictor models (e.g., effect predictor model 152) that are causal inference machine learning models.

In some embodiments, the policy generator 116 can generate policies for various use cases, such as the marketing workflow and healthcare workflow use cases, described above. In some embodiments, a user defines the decision in a workflow and maps the decision to historical data, which is then used to train an effect predictor model and to generate a policy. For example, in some embodiments, the policy generator 116 can provide a user interface (UI) that permits a user to define a decision based on his or her domain expertise and map the decision to historical data. In such cases, the policy generator 116 can also provide tools that assist the user in defining the decision. For example, in some embodiments, one or more of the tools can display historical data that is helpful to a user in defining a decision and/or display historical data associated with a decision that a user has already defined, and the user can define, validate and/or modify a decision (or not modified the decision) after viewing the historical data.

The model trainer 412 trains an effect predictor model (e.g., effect predictor model 152), which as described can be a causal inference machine learning model takes features as input and outputs an estimated effect of an action on an outcome given the features, based on the features 404, actions 406, and outcomes 408. The effect predictor model essentially learns, through the training process and based on the features 404, actions 406, and outcomes 408 in the training data, the outcome when certain actions are taken for certain features and which actions are preferable. In order to train an effect predictor model, it is assumed that the policy used to generate the actions 406 relied on features that are included in the features 404. The model trainer 412 can train the effect predictor model in any technically feasible manner in some embodiments. In some embodiments in which a policy has two arms (i.e., potential actions), the policy generator can train the effect predictor model on one arm of the policy and then perform domain transfer (adaptation) to extrapolate the trained effect predictor model to the other arm of the policy. Returning to the marketing workflow example, the policy could have two arms associated with the actions of contacting a lead and not contacting the lead. Assume that it is known using domain knowledge that a lead cannot convert if the lead is not contacted. In such cases, the model trainer 412 can train an effect predictor model on the arm associated with the action of contacting a lead based on historical data from when leads were contacted. Then, the policy generator 116 can perform domain transfer (adaptation) to extrapolate the effect predictor model that has been trained on the policy arm associated with the action of contacting a lead to the other policy arm associated with not contacting the lead. An effect can then be calculated as the difference between the predictions for each action. Returning to the marketing workflow example, when the prediction for the action of “do not contact” is 0, the difference is just the value of the prediction for the “contact” action. In some embodiments, the domain transfer to extrapolate the effect predictor model to the other policy arm can include training, using the features 404, actions 406, and outcomes 408, another machine learning model (not shown) to predict whether the trained effect predictor model can predict effect estimates given a set of features. During the domain transfer, the other machine learning model learns when the effect predictor model that was trained on one arm of the policy can be extrapolated to the other arm because the features of the data set used to train the effect predictor model (e.g., the features of leads who were contacted in the marketing workflow example) are sufficiently similar to features of a data set associated with the other arm of the policy (e.g., the features of leads who were not contacted in the marketing workflow example). In some embodiments, the other machine learning model can be a propensity score model that is trained to predict a balancing score indicating whether features are from the data set used to train the effect predictor model or the data set associated with the other arm of the policy. Then, during deployment, the trained effect predictor model can be used to predict effect estimates only when the other machine learning model predicts that the trained effector model is able to predict effect estimates for a new set of features, such as when the propensity score model predicts a balancing score indicating the new features are at least in part from the data set used to train the effect predictor model. In some embodiments, when a policy has more than two arms, the above approach for a two-arm policy can be repeated multiple times to, for example, train multiple effect predictor models that predict the estimated effects of different actions relative to a baseline. In some embodiments, when a policy has more than two arms, an effect predictor model that can predict the outcomes for multiple different actions, such as a k-learner model, can be trained.

After the effect predictor model has been trained, the policy generator 116 generates a policy based on the trained effect predictor model. In some embodiments, the policy includes a thin wrapper around the effect predictor model that converts an effect estimate output by the trained effect predictor model into an action. In such cases, the policy can be any technically feasible function of the effect estimate output by the trained effect predictor model (and potentially other inputs). For example, in some embodiments, the policy is a threshold over effect estimates output by the trained effect predictor model. As another example, in some embodiments, the policy can also take into account any suitable factors, such as seasonality, the weather, a budget, etc. As a specific example, in some embodiments, the policy can be to do an action A if the CATE is positive, and not do A if the CATE is negative. In such cases, the policy can be defined by setting a threshold over the CATE estimates:

$${π}_{th} ( τ ) = \{ \begin{matrix}do A , & τ \geq th \\ not do A , & τ < th\end{matrix} ,$$

where τ is the effect estimate by the effect predictor model and th is the threshold. When the action A is only performed if the CATE is positive, the threshold can be set to th=0. Advantageously, the actions that are output by the policy can improve the outcomes of workflows relative to prior art techniques, such as user-determined actions based on scores calculated using metrics and heuristics or outcomes predicted using a trained machine learning model. Returning to the marketing workflow example, the disclosed techniques can generate actions while accounting for leads who would or would not have converted irrespective of being contacted and leads for whom being contacted has an adverse effect on conversion.

In some embodiments, the policy generator 116 generates a different policy for each of a number of decision points, and the policy generator selects one of the policies associated with a highest evaluation score as the policy 152 that is output by the policy generator 116. Returning to the marketing workflow example, in some embodiments, the decision points are different times (e.g., days) that a lead can be contacted. In such cases, the policy generator 116 can generate a different policy for each day. Then, the policy generator 116 can determine an evaluation score for each policy indicating how many additional lead conversions are expected using the policy, such as by performing an off-policy policy evaluation (OPE) using the self-normalizing importance sampling technique, and the policy generator 116 can select one of the policies that is associated with a highest evaluation score. In such cases, the OPE can include determining instances in which outputs of the policy agree with historical data, and extrapolating such instances to the entire data set.

In some embodiments, after generating a policy (or selecting a policy at a decision point associated with a highest evaluation score), the policy generator 116 can further evaluate the policy and present the evaluation results to a user for review and approval prior to deployment of the policy for use. For example, in some embodiments, the policy generator can evaluate the policy on historical data and present the evaluation results to a user for review and approval.

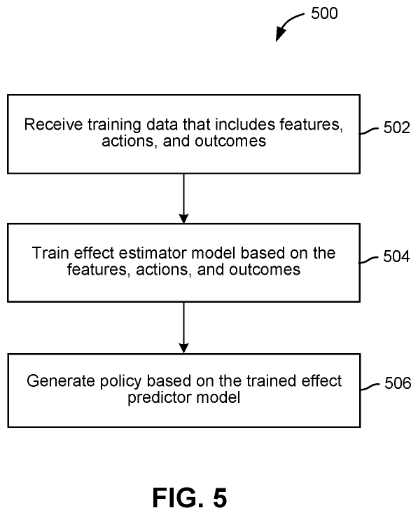

FIG. 5 sets forth a flow diagram of method steps for generating a policy, according to various embodiments. Although the method steps are described in conjunction with the systems of FIGS. 1-4, persons of ordinary skill in the art will understand that any system configured to perform the method steps, in any order, is within the scope of the present disclosure.

As shown, a method 500 begins at step 502, where the policy generator 116 receives training data that includes features, actions, and outcomes. In some embodiments, the training data can include historical data associated with workflows that have been performed.

At step 504, the policy generator 116 trains an effect predictor model based on the features, actions, and outcomes. As described, the trained effect predictor model is a causal inference machine learning model that takes features as input and outputs an estimated effect of an action on an outcome given the features, which can be a difference in the probability of the outcome between performing and not performing the action.

At step 506, the policy generator 116 generates a policy based on the trained effect predictor model. In some embodiments, the policy generator 116 generates the policy as a function of effect estimates output by the trained effect predictor model (and potentially other inputs), such as by setting a threshold over effect estimates output by the trained effect predictor model, as described above in conjunction with FIGS. 3-4.

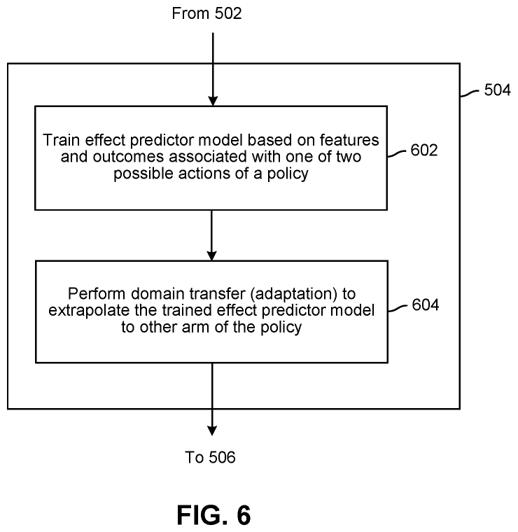

FIG. 6 sets forth a flow diagram of method steps for training the effect predictor model at step 504, according to various embodiments. Although the method steps are described in conjunction with the systems of FIGS. 1-4, persons of ordinary skill in the art will understand that any system configured to perform the method steps, in any order, is within the scope of the present disclosure.

As shown, at step 602, the policy generator 116 trains an effect predictor model based on the features and outcomes associated with one of two possible actions of a policy. Step 602 assumes that the policy being generated is a binary policy having two arms. Returning to the marketing workflow example, the policy could have two arms associated with the actions of contacting a lead and not contacting the lead. As described, assuming that it is known using domain knowledge that a lead cannot convert if the lead is not contacted, the policy generator 116 could train an effect predictor model on the arm associated with the action of contacting a lead based on historical data from when leads were contacted.

At step 604, the policy generator 116 performs domain transfer (adaptation) to extrapolate the trained effect predictor model to the other arm of the policy. In some embodiments, the domain transfer to extrapolate the effect predictor model to the other policy arm can include training, using historical features, actions, and outcomes in a training data set, another machine learning model (e.g., a propensity score model) to predict whether the trained effect predictor model is able to predict effect estimates for a new set of features (e.g., a new set of features associated with a lead in the marketing workflow example). In such cases, the trained effect predictor model can be used to predict effect estimates during deployment only when the other machine learning model predicts that the trained effector model is able to predict effect estimates for a new set of features.

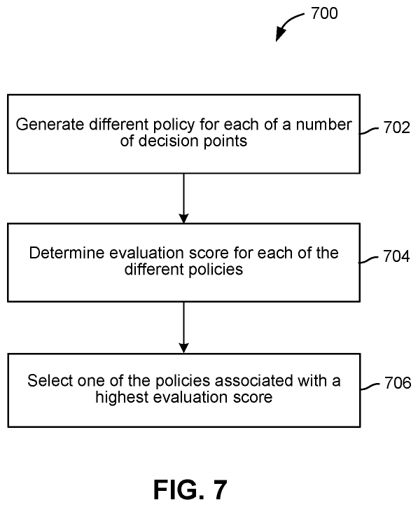

FIG. 7 sets forth a flow diagram of method steps for selecting a policy associated with a decision point, according to various embodiments. Although the method steps are described in conjunction with the systems of FIGS. 1-4, persons of ordinary skill in the art will understand that any system configured to perform the method steps, in any order, is within the scope of the present disclosure.

As shown, a method 700 begins at step 702, where the policy generator 116 generates a different policy for each of a number of decision points. In some embodiments, each policy can be generated according to the method 500 described above in conjunction with FIGS. 5-6. Returning to the marketing workflow example, in some embodiments, the decision points are different times (e.g., days) that a lead can be contacted. In such cases, the policy generator 116 can generate a different policy for each day, for example.

At step 704, the policy generator 116 determines an evaluation score for each of the different policies. The policy generator 116 can determine any technically feasible evaluation score in some embodiments. For example, in some embodiments, the policy generator 116 can perform an OPE using the self-normalizing importance sampling technique to determine the evaluation score for each of the different policies.

At step 706, the policy generator 116 selects one of the policies associated with a highest evaluation score. Returning to the marketing workflow example, the policy generator 116 can select one of the policies for a particular day that is associated with the highest evaluation score.

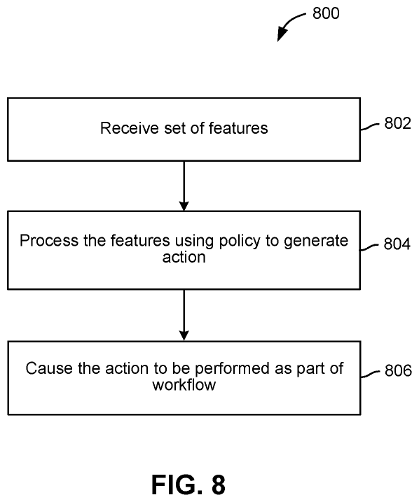

FIG. 8 sets forth a flow diagram of method steps for making workflow decisions using a policy model, according to various embodiments. Although the method steps are described in conjunction with the systems of FIGS. 1-4, persons of ordinary skill in the art will understand that any system configured to perform the method steps, in any order, is within the scope of the present disclosure.

As shown, a method 800 begins at step 802, where the workflow application 146 receives a set of features. Returning to the marketing workflow example, the workflow application 146 could receive a set of features associated with a new lead, for which the workflow application should generate an action to contact the new lead or not contact the new lead.

At step 804, the workflow application 146 processes the features using the policy 150 to generate an action. In some embodiments, the policy 150 can be generated (e.g., according to the methods 500 and 700 described above in conjunction with FIGS. 5-7) to take as input features and to output an action. In some embodiments, when domain transfer is used to extrapolate a trained effect predictor model of the policy 150 from one policy arm to another policy arm, the workflow application 146 can use the trained effect predictor model to predict effect estimates for the policy 150 only when another machine learning model that was trained during the domain transfer predicts that the trained effector model is able to predict effect estimates for a new set of features. In some embodiments, when the other machine learning model predicts that the trained effector model cannot predict effect estimates for a new set of features, the workflow application 146 can indicate to a user that an action cannot be generated or output a default action, such as not contacting a lead in the marketing workflow example. In some other embodiments, when the other machine learning model predicts that the trained effector model cannot predict effect estimates for a new set of features, the workflow application 146 can output a randomly selected action from the potential actions.

At step 806, the workflow application 146 causes the action to be performed as part of a workflow. The workflow application 146 can cause the action to be performed in any technically feasible manner in some embodiments. In some embodiments, causing the action to be performed includes transmitting one or more messages to one or more computing devices based on the first action. In some embodiments, the workflow application 146 can perform the action. Returning to the marketing workflow example, the workflow application 146 could automatically email or otherwise contact one or more marketing leads via computing device(s) owned by the one or more marketing leads. In some embodiments, the workflow application 146 can transmit message(s) indicating the action to computing device(s) belonging to user(s), and the user(s) can perform the action (or choose not to perform the action).

In sum, techniques are disclosed for automated decision making in workflows. In some embodiments, a policy generator trains an effect predictor model using training data that includes features, actions, and outcomes from historical data. The effect predictor model is a trained causal inference machine learning model that takes features as input and outputs an estimated effect of an action on an outcome given the features. In some embodiments in which a policy has two arms, the policy generator can train the effect predictor model on one arm of the policy and then perform domain transfer (adaptation) to extrapolate the trained effect predictor model to the other arm of the policy. The policy generator generates a policy based on the trained effect predictor model by, for example, setting a threshold over effect estimates output by the effect predictor model. In some embodiments, the policy generator generates a different policy for each of a number of decision points, and the policy generator selects one of the policies associated with a highest evaluation score. Once generated, a policy can be used to determine an action at a decision in a workflow given new features.

At least one technical advantage of the disclosed techniques relative to the prior art is that, in the disclosed techniques, machine learning models are trained and then used to generate prescriptive actions to perform in workflows, as opposed to predicting outcomes assuming that decisions are made according to training data that was used to train a machine learning model. The prescriptive actions can be generated and performed automatically, without requiring intervening user judgment. In addition, experience has shown that the prescriptive actions can be relatively effective. These technical advantages represent one or more technological improvements over prior art approaches.

1. In some embodiments, a computer-implemented method for automated decision making comprises receiving a first set of features associated with a decision in a workflow, generating, using a trained causal inference machine learning model that predicts one or more effects of one or more actions on an outcome, a first action to perform in the workflow based on the first set of features, and transmitting one or more messages to one or more computing devices based on the first action.

2. The computer-implemented method of clause 1, further comprising performing one or more operations to train an untrained causal inference machine learning model on a first arm of a policy model to generate the trained causal inference machine learning model, and performing one or more domain transfer operations to extrapolate the trained causal inference machine learning model to a second arm of the policy model.

3. The computer-implemented method of clauses 1 or 2, wherein performing the one or more domain transfer operations comprises performing one or more operations to train an untrained machine learning model to determine whether the trained causal inference machine learning model can make a prediction given a set of features.

4. The computer-implemented method of any of clauses 1-3, wherein training data used to generate the trained causal inference machine learning model includes a second set of features, one or more actions associated with the second set of features, and one or more outcomes associated with the one or more actions associated with the second set of features.

5. The computer-implemented method of any of clauses 1-4, wherein the trained causal inference machine learning model is included in a policy model, and the policy model is selected from a plurality of policy models associated with different decision points based on an evaluation score computed for each of the plurality of policy models.

6. The computer-implemented method of any of clauses 1-5, wherein generating the first action using the trained causal inference machine learning model comprises selecting the first action from a set of actions based on an output of the trained causal inference machine learning and a function.

7. The computer-implemented method of any of clauses 1-6, wherein the trained causal inference machine learning model comprises at least one of a causal forest model, a logistical regression model, or a neural network.

8. The computer-implemented method of any of clauses 1-7, wherein the trained causal inference machine learning model comprises an ensemble of uplift random forest models.

9. The computer-implemented method of any of clauses 1-8, wherein generating the first action comprises using the trained causal inference machine learning model to predict an effect of the first action on the outcome.

10. The computer-implemented method of any of clauses 1-9, wherein the trained causal inference machine learning model is trained to output a difference in probability of the outcome between performing the one or more actions and not performing the one or more actions.

11. In some embodiments, one or more non-transitory computer-readable storage media include instructions that, when executed by one or more processing units, cause the one or more processing units to perform steps for automated decision making, the steps comprising receiving a first set of features associated with a decision in a workflow, generating, using a trained causal inference machine learning model that predicts one or more effects of one or more actions on an outcome, a first action to perform in the workflow based on the first set of features, and transmitting one or more messages to one or more computing devices based on the first action.

12. The one or more non-transitory computer-readable storage media of clause 11, wherein the instructions, when executed by the one or more processing units, further cause the one or more processing units to perform the steps of performing one or more operations to train an untrained causal inference machine learning model on a first arm of a policy model to generate the trained causal inference machine learning model, and performing one or more domain transfer operations to extrapolate the trained causal inference machine learning model to a second arm of the policy model.

13. The one or more non-transitory computer-readable storage media of clauses 11 or 12, wherein training data used to generate the trained causal inference machine learning model includes a second set of features, one or more actions associated with the second set of features, and one or more outcomes associated with the one or more actions associated with the second set of features.

14. The one or more non-transitory computer-readable storage media of any of clauses 11-13, wherein the trained causal inference machine learning model is included in a policy model, and the policy model is selected from a plurality of policy models associated with different decision points based on an evaluation score computed for each of the plurality of policy models.

15. The one or more non-transitory computer-readable storage media of any of clauses 11-14, wherein generating the first action using the trained causal inference machine learning model comprises selecting the first action from a set of actions based on an output of the trained causal inference machine learning and a predefined threshold.

16. The one or more non-transitory computer-readable storage media of any of clauses 11-15, wherein the trained causal inference machine learning model comprises at least one of a causal forest model, a logistical regression model, or a neural network.

17. The one or more non-transitory computer-readable storage media of any of clauses 11-16, wherein the trained causal inference machine learning model comprises an ensemble of uplift random forest models.

18. The one or more non-transitory computer-readable storage media of any of clauses 11-17, wherein generating the first action comprises using the trained causal inference machine learning model to predict an effect of the first action on the outcome.

19. The one or more non-transitory computer-readable storage media of any of clauses 11-18, wherein the trained causal inference machine learning model is trained to output a difference in probability of the outcome between performing the one or more actions and not performing the one or more actions.

20. In some embodiments, a system comprises one or more memories storing instructions, and one or more processors that are coupled to the one or more memories and, when executing the instructions, are configured to receive a first set of features associated with a decision in a workflow, generate, using a trained causal inference machine learning model that predicts one or more effects of one or more actions on an outcome, a first action to perform in the workflow based on the first set of features, and transmitting one or more messages to one or more computing devices based on the first action.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for automated decision making, the method comprising:
receiving a first set of features associated with a decision in a workflow;
generating, using a trained causal inference machine learning model that predicts one or more effects of one or more actions on an outcome, a first action to perform in the workflow based on the first set of features; and
transmitting one or more messages to one or more computing devices based on the first action.

2. The computer-implemented method of claim 1, further comprising:
performing one or more operations to train an untrained causal inference machine learning model on a first arm of a policy model to generate the trained causal inference machine learning model; and
performing one or more domain transfer operations to extrapolate the trained causal inference machine learning model to a second arm of the policy model.

3. The computer-implemented method of claim 2, wherein performing the one or more domain transfer operations comprises performing one or more operations to train an untrained machine learning model to determine whether the trained causal inference machine learning model can make a prediction given a set of features.

4. The computer-implemented method of claim 1, wherein training data used to generate the trained causal inference machine learning model includes a second set of features, one or more actions associated with the second set of features, and one or more outcomes associated with the one or more actions associated with the second set of features.

5. The computer-implemented method of claim 1, wherein the trained causal inference machine learning model is included in a policy model, and the policy model is selected from a plurality of policy models associated with different decision points based on an evaluation score computed for each of the plurality of policy models.

6. The computer-implemented method of claim 1, wherein generating the first action using the trained causal inference machine learning model comprises selecting the first action from a set of actions based on an output of the trained causal inference machine learning and a function.

7. The computer-implemented method of claim 1, wherein the trained causal inference machine learning model comprises at least one of a causal forest model, a logistical regression model, or a neural network.

8. The computer-implemented method of claim 1, wherein the trained causal inference machine learning model comprises an ensemble of uplift random forest models.

9. The computer-implemented method of claim 1, wherein generating the first action comprises using the trained causal inference machine learning model to predict an effect of the first action on the outcome.

10. The computer-implemented method of claim 1, wherein the trained causal inference machine learning model is trained to output a difference in probability of the outcome between performing the one or more actions and not performing the one or more actions.

11. One or more non-transitory computer-readable storage media including instructions that, when executed by one or more processing units, cause the one or more processing units to perform steps for automated decision making, the steps comprising:
receiving a first set of features associated with a decision in a workflow;
generating, using a trained causal inference machine learning model that predicts one or more effects of one or more actions on an outcome, a first action to perform in the workflow based on the first set of features; and
transmitting one or more messages to one or more computing devices based on the first action.

12. The one or more non-transitory computer-readable storage media of claim 11, wherein the instructions, when executed by the one or more processing units, further cause the one or more processing units to perform the steps of:
performing one or more operations to train an untrained causal inference machine learning model on a first arm of a policy model to generate the trained causal inference machine learning model; and
performing one or more domain transfer operations to extrapolate the trained causal inference machine learning model to a second arm of the policy model.

13. The one or more non-transitory computer-readable storage media of claim 11, wherein training data used to generate the trained causal inference machine learning model includes a second set of features, one or more actions associated with the second set of features, and one or more outcomes associated with the one or more actions associated with the second set of features.

14. The one or more non-transitory computer-readable storage media of claim 11, wherein the trained causal inference machine learning model is included in a policy model, and the policy model is selected from a plurality of policy models associated with different decision points based on an evaluation score computed for each of the plurality of policy models.

15. The one or more non-transitory computer-readable storage media of claim 11, wherein generating the first action using the trained causal inference machine learning model comprises selecting the first action from a set of actions based on an output of the trained causal inference machine learning and a predefined threshold.

16. The one or more non-transitory computer-readable storage media of claim 11, wherein the trained causal inference machine learning model comprises at least one of a causal forest model, a logistical regression model, or a neural network.

17. The one or more non-transitory computer-readable storage media of claim 11, wherein the trained causal inference machine learning model comprises an ensemble of uplift random forest models.

18. The one or more non-transitory computer-readable storage media of claim 11, wherein generating the first action comprises using the trained causal inference machine learning model to predict an effect of the first action on the outcome.

19. The one or more non-transitory computer-readable storage media of claim 11, wherein the trained causal inference machine learning model is trained to output a difference in probability of the outcome between performing the one or more actions and not performing the one or more actions.

20. A system, comprising:
one or more memories storing instructions; and
one or more processors that are coupled to the one or more memories and, when executing the instructions, are configured to:
receive a first set of features associated with a decision in a workflow,
generate, using a trained causal inference machine learning model that predicts one or more effects of one or more actions on an outcome, a first action to perform in the workflow based on the first set of features; and
transmitting one or more messages to one or more computing devices based on the first action.
